(19) United States
(12) Patent Application Publication
(10) Pub. No.: US 2024/0322209 A1
(43) Pub. Date: Sep. 26, 2024

(54) ELECTROCHEMICAL REACTOR SUITABLE FOR PRODUCING HYDROGEN ON DEMAND AND COMPRISING AN IMPROVED DEVICE FOR STORING AND SUPPLYING HYDROGEN

(71) Applicant: ERGOSUP, MALATAVERNE (FR)

(72) Inventors: Jean-Edmond Chaix, MALATAVERNE (FR); Patrick Paillère, MALATAVERNE (FR)

(21) Appl. No.: 18/561,827

(22) PCT Filed: May 18, 2022
(86) PCT No.: PCT/EP2022/063457

§ 371 Date: Jun. 7, 2024

(30) Foreign Application Priority Data
May 19, 2021 (FR) FR2105219

(51) Int. Cl. H01M 8/0656; C25B 1/04; C25B 9/65; H01M 8/04082

(52) U.S. Cl. CPC H01M 8/0656; C25B 1/04; C25B 9/65; H01M 8/04201

(57) ABSTRACT

An electrochemical reactor adapted to produce hydrogen on demand, including: a device for storing and supplying hydrogen, which includes: a solid-phase metal M layer, and an aqueous liquid electrolyte € adapted to oxidise the layer of a metal solid-phase M; a main chamber; a control device, adapted to ensure a relative movement between the electrolyte and the metal M layer so as to be able to present the following two configurations: a withdrawal configuration wherein there is a separation between the electrolyte and the metal M layer; and a contact configuration in which there is contact between the electrolyte and the metal M layer in the main chamber.

### TECHNICAL FIELD

The field of the invention is that of electrochemical reactors adapted to produce gaseous hydrogen on demand, which include a device allowing storing the hydrogen in a non-gaseous form then supplying the hydrogen in gaseous form. Such an electrochemical reactor finds particular application in the field of hydrogen electric generators, i.e. electric generators including an electrochemical reactor supplying gaseous hydrogen to a hydrogen engine which then produces electrical energy. Such hydrogen electric generators could be used as generator sets.

### PRIOR ART

There are electrochemical reactors adapted to produce gaseous hydrogen on demand, in particular to supply gaseous hydrogen to a fuel cell. The electrochemical reactor and the fuel cell then form a hydrogen electric generator.

Thus, hydrogen electric generators are systems adapted to produce electrical energy from hydrogen. They include a hydrogen engine, for example a fuel cell, and a device for storing and supplying hydrogen to the hydrogen engine. They may be used as generator sets, i.e. as standalone sources of electrical energy adapted to supply electricity for all kinds of stationary or mobile applications, for example to overcome an interruption in the power supply by the mains grid or by the main electrical source.

The fuel cell uses hydrogen as a fuel and oxygen as an oxidiser (air or pure oxygen). For example, it may be a proton-exchange membrane fuel cell (PEMFC), and possibly a solid-oxide fuel cell (SOFC).

According to one example, the storage and supply device is adapted to store hydrogen during the standby phase of the electric generator, i.e. when the production of electrical energy is not required, then supply hydrogen to the fuel cell when the electrical energy production phase is initiated. For example, the storage and supply device could store hydrogen bottles under pressure at several hundred bars, for example at 200 bar, proximate to the fuel cell. The empty bottles are regularly returned to the supplier to be refilled.

However, this solution has the drawback of having to potentially store a large number of hydrogen bottles under pressure, depending on the amount of electrical energy to be supplied, this storage taking place proximate to the consumer equipment (hospital, computer data centre, etc.), which might pose problems in terms of safety. In addition, hydrogen resupply involves a considerable cost in terms of pollution (production of hydrogen from hydrocarbons, movement of dedicated trucks, etc.) and energy (use of a compressor to fill the bottles at high pressure, etc.).

According to another example, illustrated in the document U.S. Pat. No. 8,858,910B2, the electric generator may include an electrochemical reactor adapted to produce hydrogen on demand. More specifically, the electrochemical reactor includes a storage and supply device allowing producing gaseous hydrogen by aluminium-assisted electrolysis of water, thereby supplying a fuel cell.

However, in operation, the gaseous hydrogen production reaction ends when there is no longer any solid aluminium. It is then necessary to open the chamber to remove the liquid electrolyte, to clean the chamber, before refilling the electrochemical reactor with alkaline electrolyte rich in sodium hydroxide on the one hand, and in solid aluminium on the other hand. This requires a substantial intervention from the user after each gaseous hydrogen production step, which in particular reduces the ease of use of the electrochemical reactor and reduces the duration during which the electric generator is actually operational.

### DISCLOSURE OF THE INVENTION

The invention aims to overcome at least partially the drawbacks of the prior art, and more particularly to provide an electrochemical reactor adapted to produce gaseous hydrogen on demand, including an improved hydrogen storage and delivery device, which then have reduced risks in terms of safety. In particular, such an electrochemical reactor may be present in a hydrogen electric generator.

For this purpose, an object of the invention is an electrochemical reactor intended to produce gaseous hydrogen on demand. It includes a hydrogen storage and supply device and a control device.

The hydrogen storage and supply device is adapted to store hydrogen in a non-gaseous form and to produce and supply gaseous hydrogen. It includes: a layer of a solid-phase metal M with a redox couple Mⁿ⁺/M, and an aqueous liquid electrolyte adapted to oxidise the layer of the solid-phase metal M resulting in the production of gaseous hydrogen; and a main chamber, adapted to receive the electrolyte and the layer of the solid-phase metal M, and including an outlet for supplying gaseous hydrogen.

The control device is adapted to ensure a relative movement between the electrolyte and the metal M layer, so as to be able to successively present at least the following two configurations: a withdrawal configuration during a standby phase, where there is a physical separation between the electrolyte and the metal M layer; and a contact configuration during a production phase, where there is physical contact between the electrolyte and the metal M layer in the main chamber, resulting in the oxidation of this metal M layer by the electrolyte and therefore in the production of gaseous hydrogen.

By successively, it should be understood that a use cycle of the electrochemical reactor includes at least one standby phase and one production phase, and that there could be several use cycles which follow one another.

According to the invention, the hydrogen storage and supply device includes:
a secondary chamber, fluidly connected to the main chamber, and adapted to receive the electrolyte at least during the standby phase;
a negative electrode and a positive electrode, and an electric power supply connected to the electrodes, the control device being adapted to present: a contact configuration during a preparation phase, following a production phase, in which there is physical contact between the electrolyte and the electrodes, the electric power supply being activated, resulting in a deposition of the solid-phase metal M layer over the negative electrode and in a production of gaseous oxygen at the electrode positive, the metal layer M thus formed being intended to be oxidised by the electrolyte during a subsequent production phase.

The negative and positive electrodes are located: either in the main chamber; or in an intermediate chamber fluidly connected to the secondary chamber, the control device then being adapted to move the metal layer M from the intermediate chamber following the preparation phase, into the main chamber for the production phase.

Some preferred, yet non-limiting, aspects of this hydrogen electric generator are as follows.

The main chamber and the secondary chamber may be connected to each other by an electrolyte recirculation circuit.

The electrolyte may have a volume larger than that of the main chamber and smaller than or equal to that of the secondary chamber. Thus, during a production phase, it could completely fill the main chamber and a portion of the secondary chamber.

Similarly, in the case where the negative and positive electrodes are located in the intermediate chamber, the electrolyte may have a volume larger than that of the intermediate chamber and smaller than or equal to that of the secondary chamber. Thus, during a preparation phase, it could completely fill the intermediate chamber and a portion of the secondary chamber.

The secondary chamber may be located above the main chamber, the recirculation circuit including discharge and recirculation ducts, the discharge duct opening onto an upper port of the main chamber and the recirculation duct opening onto a lower port of the secondary chamber.

The hydrogen storage and supply device may be adapted to move, during the production phase, at least one portion of the electrolyte by gravity in the main chamber, to come into contact with the solid-phase metal M layer.

The secondary chamber may be located above the intermediate chamber and the main chamber, and may be connected: to the intermediate chamber via a discharge duct and a recirculation duct, the discharge duct opening onto an upper port of the intermediate chamber and the recirculation duct opening onto a lower port of the secondary chamber so as to enable a recirculation of the electrolyte between the secondary and intermediate chambers during the preparation phase; and to the main chamber via a discharge duct and a recirculation duct, the discharge duct opening onto an upper port of the main chamber and the recirculation duct opening onto a lower port of the secondary chamber so as to enable a recirculation of the electrolyte between the secondary and main chambers during the electrical energy production phase.

The storage and supply device may include a transfer duct connecting the intermediate chamber and the secondary chamber, and opening onto a lower port of the intermediate chamber.

The invention also relates to a hydrogen electric generator, intended to produce electrical energy from gaseous hydrogen, and including: an electrochemical reactor according to any one of the preceding features; and a hydrogen engine, adapted to produce electrical energy from the gaseous hydrogen supplied by the storage device and provision of the electrochemical reactor, including an inlet manifold for receiving the hydrogen, connected to the main chamber.

The hydrogen engine may be connected to the main chamber via the secondary chamber.

The invention also relates to a method for producing gaseous hydrogen by an electrochemical reactor according to any one of the preceding features, including the following steps:
during the standby phase, physical separation of the electrolyte and the solid metal M layer, by the control device, so as to present the withdrawal configuration; then
during the production phase, bringing the electrolyte and the solid-phase metal M layer into contact in the main chamber, by the control device, resulting in the oxidation of this layer of the solid-phase metal M by the electrolyte and therefore in the production of gaseous hydrogen; then
during the preparation phase, bringing the electrolyte into contact with the negative and positive electrodes, the electric power supply being activated, resulting in a deposition of the solid-phase metal M layer over the negative electrode and in a production of gaseous oxygen at the positive electrode. This preparation phase may be followed by a restocking (addition) of liquid water in the electrolyte, to compensate for the water consumed during this deposition electrochemical reaction.

The method may further include a new standby phase between the production and preparation phases.

The invention also relates to a method for producing electrical energy by the hydrogen electric generator according to any one of the preceding features, including:
during the standby phase, physical separation of the electrolyte and the solid metal M layer, by the control device, so as to present the withdrawal configuration; then
during the production phase, bringing the electrolyte and the solid-phase metal M layer into contact in the main chamber, by the control device, resulting in the oxidation of this layer of the solid-phase metal M by the electrolyte and therefore in the production of gaseous hydrogen, which is supplied to the hydrogen engine, which then produces electrical energy; then
during the preparation phase, bringing the electrolyte into contact with the negative and positive electrodes, the electric power supply being activated, resulting in a deposition of the solid-phase metal M layer over the negative electrode and in a production of gaseous oxygen at the positive electrode.

### BRIEF DESCRIPTION OF THE DRAWINGS

Other aspects, aims, advantages and features of the invention will appear better upon reading the following detailed description of preferred embodiments thereof, given as a non-limiting example, and made with reference to the appended drawings wherein:

FIG. 1 is a schematic and partial view of a hydrogen electric generator according to a first embodiment, wherein the hydrogen storage and supply device of the electrochemical reactor has a so-called dewatering configuration where the same chamber is the site of the so-called attack electrochemical reaction of production of gaseous hydrogen, and that of the so-called deposition electrochemical reaction of formation of a solid metal M layer;

FIGS. 2A to 2D are schematic and partial views of the hydrogen electric generator according to the first embodiment, illustrating different phases of operation thereof of an operation cycle, namely:
a preparation phase (FIG. 2A and FIG. 2B) including a deposition step (FIG. 2A) then a fluidic transfer step (FIG. 2B);
a standby phase (FIG. 2C); then
a gaseous hydrogen production phase (FIG. 2D);

FIG. 3 is a schematic and partial view of a hydrogen electric generator according to a variant of the first embodiment, wherein the secondary chamber is not arranged above the main chamber, but next to the latter (laterally);

FIG. 4 is a schematic and partial view of a hydrogen electric generator according to a second embodiment, wherein the hydrogen storage and supply device has a so-called mobile metal layer M configuration, where the attack electrochemical reaction (gaseous hydrogen production) takes place in a main chamber, and where the deposition electrochemical reaction (formation of a solid metal M layer) takes place in another so-called intermediate chamber;

FIGS. 5A to 5D are schematic and partial views of a hydrogen electric generator according to the second embodiment, illustrating different phases of a use cycle, namely:
the preparation phase (FIG. 5A and FIG. 5B);
the standby phase (FIG. 5C); and
the gaseous hydrogen production phase (FIG. 5D).

### DETAILED DESCRIPTION OF PARTICULAR EMBODIMENTS

In the figures and in the following description, the same references represent identical or similar elements. In addition, the different elements are not plotted to scale so as to favour clarity of the figures. Moreover, the different embodiments and variants do not exclude each other and may be combined together. Unless stated otherwise, the terms “substantially”, “about”, “in the range of” mean within a 10% margin, and preferably within a 5% margin. Moreover, the terms “comprised between . . . and . . . ” and the like mean that the bounds are included, unless stated otherwise.

The invention relates to an electrochemical reactor adapted to supply gaseous hydrogen on demand. It includes a device adapted to store hydrogen in a non-gaseous form then to supply it in a gaseous form. It finds application in particular in the context of a hydrogen electric generator, i.e. an electrical energy production system including on the one hand a hydrogen engine adapted to produce electrical energy from gaseous hydrogen and, on the other hand, the electrochemical reactor including the hydrogen storage and supply device.

Such a hydrogen electric generator is particularly adapted to for operate as a generator set, i.e. as a standalone system which could remain on standby in the absence of a need for electricity by consumer equipment (building, computer systems, etc.), and to be activated and to produce electrical energy for this consumer equipment. One should then understand that the electrochemical reactor should be able to store hydrogen over periods of time that could be long (for example in the range of a week or months), with reduced risks in terms of safety.

In other words, the electrochemical reactor has several operating phases during a use cycle, including the following main phases:
a standby phase, in which it does not produce gaseous hydrogen, the hydrogen then being stored in a non-gaseous form by the storage and supply device, herein in the electrochemical form of H⁺ ions or H₂O water molecules present in an aqueous liquid electrolyte;
a gaseous hydrogen production phase (also called attack phase), in which the storage and supply device supplies the gaseous hydrogen, for example herein to the hydrogen engine which then produces electrical energy for consumer equipment;
a preparation phase (also called deposition phase), in which the storage and supply device produces a solid metal M layer which could be oxidised during a subsequent attack phase. This deposition phase may be followed by a standby phase for a new cycle of use of the electrochemical reactor.

In general, a hydrogen engine is herein a system producing electrical energy from gaseous hydrogen. It may consist of a fuel cell, for example of the PEMFC or SOFC type, or an internal combustion engine (for example, hydrogen turbine or Wankel engine). In the following description, and for merely illustrative purposes, the hydrogen engine is a fuel cell.

According to the invention, the storage and supply device of the electrochemical reactor includes:
a layer of a solid-phase metal M of a redox couple Mⁿ⁺/M, and an aqueous liquid electrolyte adapted to oxidise the solid metal M, resulting in the production of gaseous hydrogen;
a main chamber, also called attack chamber, including an outlet port for supplying gaseous hydrogen, and adapted to receive the electrolyte and the layer of the solid metal M;
a secondary chamber, also called a storage chamber, fluidly connected to the main chamber, and adapted to receive the electrolyte at least during the standby phase;
a negative electrode and a positive electrode, and an electric power supply connected to the electrodes. The negative and positive electrodes are located: either in the main chamber; or in an intermediate chamber fluidly connected to the secondary chamber.

The electrochemical reactor also includes a control device, adapted to ensure a relative movement between the electrolyte and the metal layer M, so as to be able to present at least the following distinct configurations:
a so-called withdrawal configuration during the standby phase, in which there is a physical separation between the electrolyte and the layer of the metal M;
a so-called contact configuration during the gaseous hydrogen production phase, in which there is physical contact between the electrolyte and the layer of the metal M in the main chamber, resulting in the oxidation of the layer of the metal M by the electrolyte and therefore to a production of gaseous hydrogen;
a contact configuration during a preparation phase, following a production phase, in which there is physical contact between the electrolyte and the electrodes, the electric power supply being activated, resulting in a deposition of the solid-phase metal M layer over the negative electrode and in a production of gaseous oxygen at the positive electrode, the metal M layer thus formed being intended to be oxidised by the electrolyte during a subsequent production phase.

It should be noted that the oxidation of the metal layer M by the electrolyte equivalently corresponds to a reduction of the electrolyte by the metal M.

As detailed later on, the electrochemical reactor presents, during a use cycle, a preparation phase, performed for example before the very first standby phase (the preparation phase then being an initial phase), or performed after each gaseous hydrogen production phase, during which the storage and supply device performs a step of depositing a metal M layer (a first layer if the preparation phase is an initial phase, or a new layer if it consists of an additional phase), then a relative movement step to physically separate the electrolyte and the metal layer M.

In the following description, the electrochemical reactor is described in the context of a hydrogen electric generator. This is a merely illustrative example, to the extent that the electrochemical reactor could supply hydrogen on demand in the context of all kinds of applications.

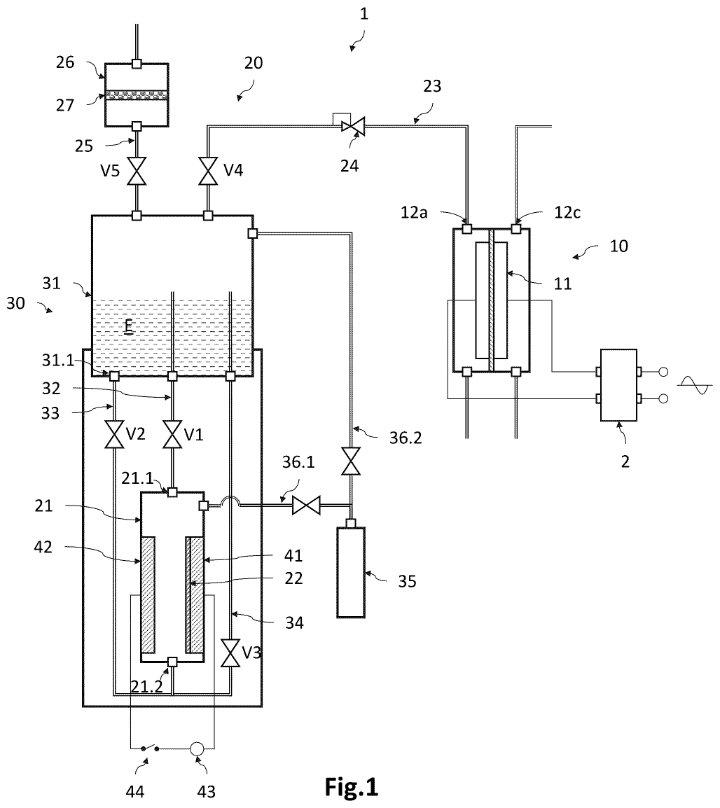

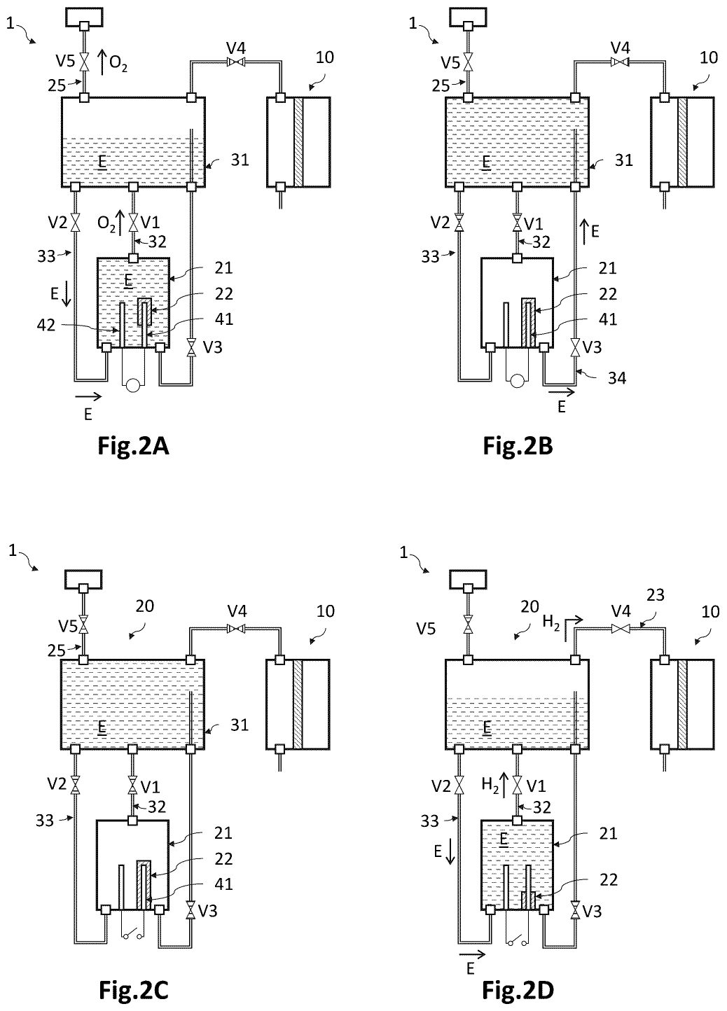

FIG. 1 is a schematic and partial view of an electrochemical reactor 1 according to one embodiment, herein in the context of a hydrogen electric generator, allowing producing electrical energy for consumer equipment (not shown).

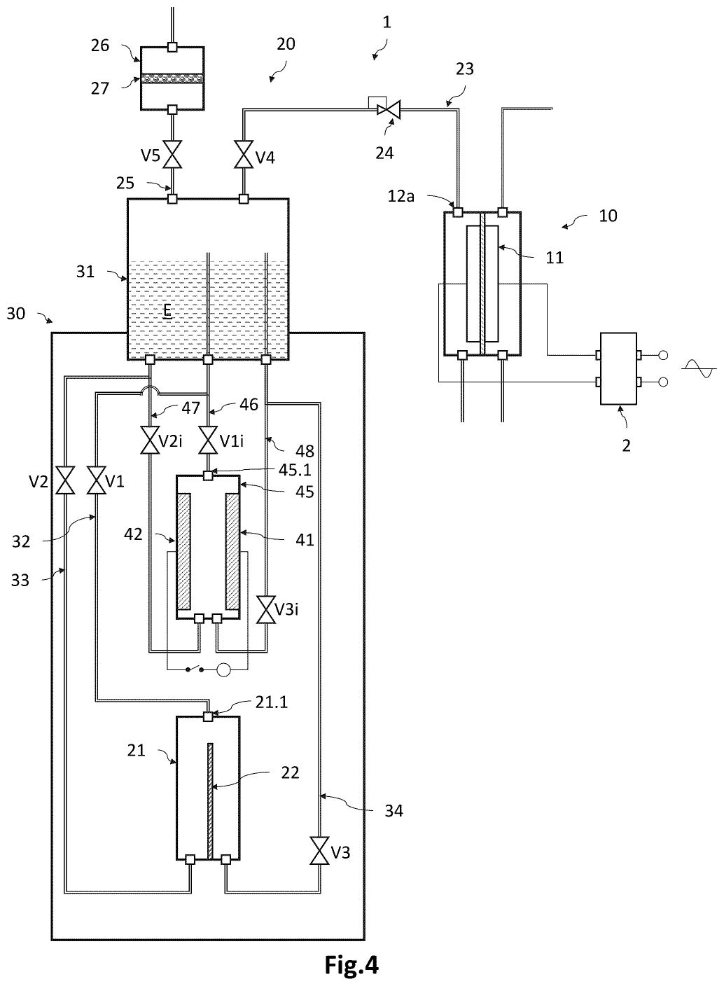

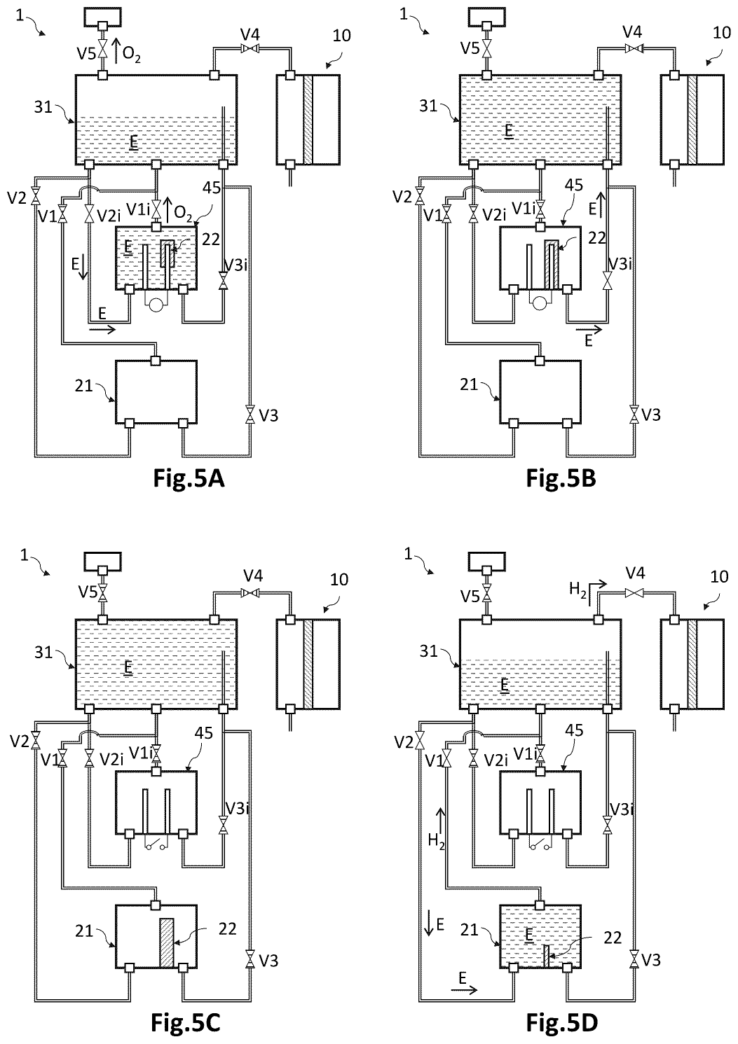

In this example, the attack main chamber 21 accommodates the electrodes 41 and 42. Hence, it is also the chamber where the electrochemical reaction for the formation of the solid metal M takes place during the preparation phase. Hence, the main chamber 21 is an attack and deposition chamber (unlike the variant in FIG. 4 where there is an attack chamber 21 and a deposition chamber 45).

The hydrogen electric generator includes the electrochemical reactor 1 having a device 20 for storing and supplying hydrogen, and herein a fuel cell 10, and more specifically herein a hydrogen cell with a proton-exchange membrane (PEM).

The fuel cell 10 includes at least one electrochemical cell, and herein a stack of electrochemical cells (not shown). Each cell includes an anode and a cathode separated from each other by an electrolytic membrane, this assembly forming a membrane electrode assembly 11 (MEA). The anode, the membrane and the cathode are conventional elements known to a person skilled in the art and are therefore not described in detail. The fuel cell 10 is supplied with hydrogen on the anode side and with air containing oxygen on the cathode side (or possibly with pure oxygen).

Each membrane electrode assembly 11 is separated from that of the adjacent cells by bipolar plates (not shown), adapted to bring the reactive species at the anode of a first cell on the one hand and at the cathode of an adjacent cell on the other hand, and to discharge the products resulting from the electrochemical reactions and the non-reactive species, as well as to transmit the electric current between the cells. It may also ensure the flow of a heat-transfer fluid between the cells so as to enable the discharge of the produced heat.

The fuel cell 10 includes two distinct inlet manifolds, an anodic one 12a and the other cathodic 12c, intended to ensure the injection of the supply gases up to the cells, and two corresponding distinct outlet manifolds, allowing discharging the supply gases that have not reacted and any non-reactive species from the fuel cell 10. Thus, the hydrogen is injected into the fuel cell 10 by the anode inlet manifold 12a which brings it to the electrochemical cells. The hydrogen that has not reacted and the non-reactive species, for example nitrogen, are then discharged through the outlet manifold.

The fuel cell 10 is adapted to supply electrical energy to consumer equipment, for example to stationary equipment such as a building (hospital, school, computer centre, etc.) and possibly to mobile equipment such as a vehicle. It may be connected to an AC/DC converter 2.

The fuel cell 10 is intended to be supplied with hydrogen, not from a hydrogen tank stored at high pressure like 200 bar bottles as in the aforementioned prior art, but from the hydrogen storage and supply device 20 according to the invention. The latter is connected to the anode inlet manifold 12a by a supply duct 23. The gaseous hydrogen supplied to the fuel cell 10 may have an atmospheric pressure or a pressure of a few bars, for example in the range of 3 bar.

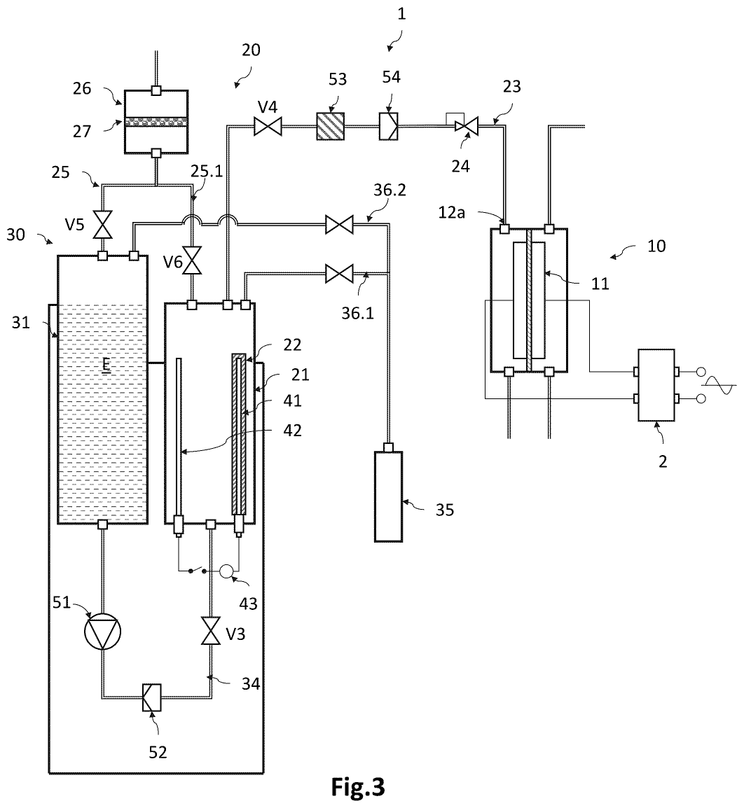

A pressure regulator 24, herein a relief valve, may be placed on the supply duct 23, between the storage and supply device 20 and the anode inlet manifold 12a. It is adapted to maintain a substantially constant downstream pressure, herein lower than the pressure of the hydrogen generated in the main chamber 21 of the storage and supply device 20, and independent of the possible pressure variations. The downstream pressure corresponds to the pressure of the hydrogen at the outlet of the relief valve 24. The value of the downstream pressure is substantially equal to the set value of the relief valve 24, this value could be controlled or not. Other fluidic elements may be arranged on the supply duct 23, as described later on with reference to FIG. 3.

It should be noted that the fuel cell 10 may also include a recirculation loop (not shown) formed on the one hand by an ejector arranged on the supply duct 23, between the relief valve 24 and the anode inlet manifold 12a and, on the other hand, a recirculation fluid line fluidly connecting the anode outlet manifold 12a to a so-called secondary inlet of the ejector. This configuration is known to a person skilled in the art and is not described in more detail.

The electrochemical reactor 1 comprises the hydrogen storage and supply device 20 and the control device 30. Thus, the storage/supply device 20 is adapted to store hydrogen, not in a gaseous form and at high pressure, but herein in the chemical form of H⁺ ions and possibly H₂O water molecules, present in an aqueous liquid electrolyte E, then supplying gaseous hydrogen to the fuel cell 10, this gaseous hydrogen having been produced from an electrochemical reaction of oxidation of a layer of the solid reducing agent M of the redox couple Mⁿ⁺/M called the redox intermediate, where M is a metal. The control device is adapted to ensure a relative movement between the electrolyte E and the solid-phase metal M layer 22.

Thus, the storage and supply device 20 includes:
a solid-phase metal M layer 22 with a redox couple Mⁿ⁺/M and an aqueous liquid electrolyte E adapted to oxidise the layer 22 of a metal M, resulting in the production of gaseous hydrogen;
a main chamber 21 (attack chamber), herein connected to the anode inlet manifold 12a to supply it with gaseous hydrogen, and intended to receive the electrolyte E and the layer 22 of the solid-phase metal M;
a secondary chamber 31 (storage chamber), fluidly connected to the main chamber 21, and adapted to receive the electrolyte (E) at least during the standby phase.

The control device 30 may have the following distinct configurations:
a withdrawal configuration during the standby phase, in which there is a physical separation between the electrolyte E and the layer 22 of the solid-phase metal M, the electrolyte E then being located entirely in the storage secondary chamber 31; and
a contact configuration during the production phase, in which there is physical contact between the electrolyte E and the layer 22 of the solid-phase metal M in the attack main chamber 21, resulting in the oxidation of this layer 22 of the metal M and therefore in the production of gaseous hydrogen;
another contact configuration during a preparation phase, following a production phase, in which there is physical contact between the electrolyte E and the electrodes 41, 42, the electric power supply 43 being activated, resulting in a deposition of the solid-phase metal M layer 22 over the negative electrode 41 and in a production of gaseous oxygen at the positive electrode 42. The metal M layer 22 thus formed is intended to be oxidised during a subsequent production phase. This contact may herein take place in the main chamber 21.

In other words, during the standby phase, i.e. when the electrochemical reactor 1 is not activated and does not produce hydrogen gas, the layer 22 of the metal M and the electrolyte E are physically separated (absence of physical contact) from each other, so as to avoid the oxidation of the layer 22 of the metal M and therefore the production of gaseous hydrogen. This mutual contact is performed when the electrochemical reactor 1 is activated and corresponds to the gaseous hydrogen production phase.

The attack main chamber 21 is formed of a wall delimiting an internal space. This is the site of the electrochemical reaction of oxidation of the solid-phase metal M layer 22 by the electrolyte E. The attack main chamber 21 is made of a corrosion-resistant material. In this example, it is connected to the fuel cell 10 to supply it with gaseous hydrogen. In this example, the main chamber 21 is connected to the fuel cell 10 indirectly, via the storage secondary chamber 31. Alternatively, it may be connected directly to the fuel cell 10, as described later on with reference to FIG. 3.

The electrolyte E is an ionic aqueous solution adapted to oxidise a layer 22 of the solid-phase metal M of the redox intermediate Mⁿ⁺/M resulting in the production of gaseous hydrogen. It may consist of an acidic solution based on H₂SO₄, and contains a predominance of H⁺ ions when the electrolyte E is in the standby phase. The H⁺ ions are then the chemical form in which hydrogen is stored during the standby phase. Yet, alternatively, the electrolyte E may be basic, the hydrogen then being stored during the standby phase in the chemical form of water molecules H₂O.

As detailed later on, the electrolyte E may initially contain Mn+ ions whose concentration (in grams per litre of electrolyte) depends on the amount of gaseous hydrogen to be produced, and may be comprised, for example, between about 10 and 100 g/L. The sulphuric acid concentration may herein be comprised, for example, between about 25 and 150 g/L, for example equal to 80 g/L.

The Mⁿ⁺/M redox intermediate, where the chemical element M is a metal, may be the Zn²⁺/Zn couple. However, other redox intermediates may be used, like for example nickel Ni or manganese Mn, inter alia. Examples are given in particular in the document WO2019/193281. As detailed later on, the electrolyte E may initially include Mn+ ions to perform afterwards, before the standby phase, an electrochemical reaction of deposition of the layer 22 of the solid metal M over the negative electrode 41 (and the formation of H⁺ ions in the case of an acidic electrolyte, or of H₂O water molecules in the case of a basic electrolyte).

The storage and supply device 20 includes electrodes 41, 42, connected to an electric power supply 43, and possibly to an electrical load (or herein connected to the AC/DC converter). These electrodes 41, 42, associated with the electric power supply 43, allow forming a first layer 22, or a new layer 22, of the solid-phase metal M. In this example, this step of forming the solid-phase metal M layer 22 (deposition step) is performed in the main chamber 21, which is then an attack and deposition chamber. Also, the electrodes 41, 42 are arranged in the main chamber 21, which is then, not only the site of the electrochemical reaction of the oxidation of the metal layer M and therefore of the production of gaseous hydrogen (attack reaction), but also the site of the electrochemical reaction of deposition of the metal M layer 22 (deposition reaction). Yet, alternatively, as indicated later on with reference to FIG. 4, this deposition step may be performed in a chamber other than the attack main chamber 21, namely in the so-called deposition intermediate chamber 45.

The electrodes 41, 42 are made of a material which depends on the nature of the electrolyte E and of the redox intermediate. For example, for an electrolyte in an acidic aqueous solution based on H₂SO₄ and a Zn²⁺/Zn redox intermediate, the negative electrode 41 (zinc electrode) may be made based on aluminium and the positive electrode 42 (oxygen electrode) may be made based on lead. Other materials may be used.

The electric power supply 43 is connected to the positive 42 and negative 41 electrodes, and is adapted to apply an electrical potential difference thereto during this deposition step. A switch 44 is intended to deactivate the electric power supply during the standby phase and during the gaseous hydrogen production phase.

It should be noted that the use of three distinct electrodes is possible, for example with a first electrode, herein so-called zinc electrode, on which the solid reducing agent is deposited, made for example of aluminium, a second electrode, so-called oxygen electrode, at which oxygen is produced, made for example of a lead alloy, and a third electrode, so-called hydrogen electrode, at which hydrogen is produced, made for example of platinum.

As detailed hereinafter, the control device 30 may in particular feature two different embodiments. In the first embodiment (cf. FIG. 1, FIG. 2A to 2D and FIG. 3), the control device 30 is so-called a dewatering control device, to the extent that the metal M layer 22 remains located in the main chamber 31 during the standby and production phases, while the electrolyte E is separated or brought into contact with the metal M layer 22 (the same chamber 21 for the attack and deposition reactions). On the other hand, in the second embodiment (cf. FIGS. 4 and 5A to 5D), the control device 30 is so-called with a movable metal M layer 22, to the extent that the metal M layer 22 is moved (mechanically or manually) between the standby and production phases (two distinct chambers for the attack and deposition reactions).

In this first embodiment, the control device 30 is dewatered, and therefore includes fluidic transfer elements adapted to transfer at least partially the electrolyte E from the storage secondary chamber 31 (which it occupied during the standby phase) towards the attack main chamber 21 (for the hydrogen production phase), and vice versa.

The storage secondary chamber 31 is connected to the attack main chamber 21 by the fluidic transfer elements. This secondary chamber 31 allows temporarily storing the electrolyte E out of the main chamber 21 during the standby phase, before the hydrogen production phase. During the hydrogen production phase, the electrolyte E is reintroduced into the attack main chamber 21 to come into contact with the solid-phase metal M layer 22 and. The storage secondary chamber 31 may be made of a material selected to resist the sulphuric acid of the electrolyte E.

It should be noted that, in general, different configurations are of course possible to ensure the fluidic transfer of the electrolyte E from one chamber 21, 31 to another, depending on whether the movement of the electrolyte E is passive (by gravity) or controlled (pump, injection of a gas under pressure, etc.), and therefore according to the arrangement of the storage secondary chamber 31 with respect to the attack main chamber 21.

Thus, in this example of FIG. 1, the storage secondary chamber 31 is placed above the attack main chamber 21, the fluidic transfer of the electrolyte E from the main chamber 21 towards the secondary chamber 31 to switch into the withdrawal configuration is herein a transfer ensured by the production of gaseous oxygen during a preparation phase. This transfer may be assisted by the injection of a neutral gas (nitrogen or air) into the main chamber 21, and possibly may be assisted by means of a pump (not shown).

In this case, a discharge duct 32 ensures the fluidic connection between an upper port 21.1 of the attack main chamber 21 and the storage secondary chamber 31, and is provided with a valve V1. A transfer duct 34 ensures the fluidic connection between a lower port 21.2 of the main chamber 21 and the secondary chamber 31, is provided with a valve V2. Finally, a recirculation duct 33 ensures the fluidic connection between the main chamber 21 and a lower port 31.1 of the secondary chamber 31. Of course, the inlet/outlet ports may be arranged differently from the arrangement illustrated in FIG. 1.

The storage secondary chamber 31 is connected to the anode inlet manifold 12a by a supply duct 23 provided with a relief valve 24, which ensures the regulation of the pressure of the gaseous hydrogen at the inlet of the anode of the fuel cell 10. In addition, the storage secondary chamber 31 is herein connected to a degasser 26 at atmospheric pressure via a discharge duct 25 provided with a valve V5. This degasser 26 allows diluting the released oxygen in the open air and then, possibly, releasing it into the atmosphere. It herein includes a filter 27 allowing cleaning the oxygen from the acid mist possibly present, the latter being formed of fine electrolyte droplets, before the oxygen is released into the atmosphere. Fans (not shown) may be present to ventilate the degasser 26. A hydrogen level sensor may also be present.

In the case where the fluidic transfer of the electrolyte E out of the attack main chamber 21 is assisted or ensured by the injection of a neutral gas, a pressurised gas bottle 35 is connected to an upper port of the main chamber 21 by a connection duct 36.1. This same bottle (or another) may be connected by a duct 36.2 to the storage secondary chamber 31 to assist the transfer of the electrolyte E into the main chamber 21.

Advantageously, the main chamber 21 and the storage secondary chamber 31 are herein connected to each other by a recirculation circuit (ducts 32, 33), and the electrolyte E has a sufficient volume to fill the main chamber 21 and a portion of the secondary chamber 31 during the attack and deposition phases.

It is then possible to perform a step of producing gaseous hydrogen (attack), then a step of forming solid metal M (deposition), followed by a simple addition of water to the electrolyte, then a standby step where hydrogen is stored in the ionic rather than gaseous form. And so on.

FIGS. 2A to 2D schematically and partially illustrate an electrochemical reactor 1, in the context of a hydrogen electric generator, according to an embodiment similar to that described in FIG. 1, during different stages of operation thereof. In this example, the redox intermediate is the Zn²⁺/Zn couple and the electrolyte is an aqueous and acidic liquid solution.

FIG. 2A illustrates the electrochemical reactor 1, during a first step of an initial preparation phase. This herein consists in depositing the solid zinc layer 22 (herein over the negative electrode 41) and forming H⁺ ions in the electrolyte E. Thus, these H⁺ ions correspond to the chemical form of stored hydrogen, which allows avoiding risks in terms of safety (no gaseous hydrogen stored at high pressure).

For this purpose, the electrolyte E containing Zn²⁺ ions is placed in the attack main chamber 21. The concentration of Zn²⁺ ions depends on the amount of hydrogen gas to be produced. It should be noted that the amount of electrolyte E is such that it fills the main chamber 21 as well as a portion of the secondary chamber 31. During this deposition step, the electrolyte E will circulate between the attack main chamber 21 and the storage secondary chamber 31 via the discharge 32 and recirculation 33 ducts.

For this purpose, the valves V1 (discharge) and V2 (recirculation) are open, and the valve V3 (transfer) is closed. The supply valve V4 of the fuel cell 10 is closed, and the discharge valve V5 is open. Hence, the attack main chamber 21 and the storage secondary chamber 31 are at atmospheric pressure. Finally, the electric power supply 43 is activated to apply an electrical potential difference at the electrodes, which initiates the zinc deposition electrochemical reaction.

During this deposition step, the electrolyte E is electrolysed to carry out the deposition of solid-phase zinc over the negative electrode 41. This electrochemical reaction is accompanied by the production of gaseous oxygen. In this example, the produced oxygen is discharged via the ducts 32 and 25, into the air at atmospheric pressure through the degasser and cleaned of the acid mist by the filter, before being released into the atmosphere.

The reduction of the oxidant of the redox intermediate, herein Zn²⁺ ions, takes place at the negative electrode 41 (cathode) resulting in the deposition of the solid-phase zinc layer 22, and the oxidation of water and therefore the production of gaseous oxygen then takes place at the positive electrode 42 (anode). These two chemical equations are written as follows:

$${H}_{2} O \to \frac{1}{2} {O}_{2} ( g ) + 2 {H}^{+} + 2 {e}^{-}$$

$${Zn}^{2 +} + 2 {e}^{-} \to Zn ( s )$$

The electro-deposition of zinc on the negative electrode 41 is a zinc electrolysis. It causes the acidification of the electrolyte solution. During this deposition step, there is therefore a consumption of water and electricity. Thus, the electric power supply generates a current density i for a duration Δt which results in the deposition of a mass m_{Zn} of solid-phase zinc over the negative electrode 41. Hence, there has been a decrease in the concentration of Zn²⁺ ions in the electrolyte.

During this deposition step, the oxygen is discharged out of the main chamber 21 via the discharge duct 32, which causes a rise in the electrolyte E in the discharge duct 32 by gas extraction (gas lift), and therefore a recirculation of the electrolyte E in the recirculation duct 33, which allows homogenising the concentration of Zn²⁺ ions within the electrolyte E. Following the deposition phase, a restocking of water in the electrolyte E may be carried out to compensate for the consumed water.

At the end of this first step, the solid-phase zinc layer 22 is therefore formed over the surface of the negative electrode 41. In addition, the electrolyte E contains H⁺ ions which correspond to the chemical form of the stored hydrogen. A relative movement between the electrolyte E and the solid-phase zinc layer 22 should now be ensured to switch in the withdrawal configuration of the standby phase.

FIG. 2B illustrates the electrochemical reactor 1, during a second step of the initial preparation phase. To transfer the electrolyte E out of the main chamber 21 (physical separation with the solid-phase zinc layer 22), advantage is herein taken of the production of oxygen to ensure this fluidic transfer of the electrolyte E. Hence, this step is performed before exhaustion of the Zn²⁻ ions in the electrolyte E.

For this purpose, the valves V1 (discharge) and V2 (recirculation) are closed and the valve V3 (transfer) is open. The electric power supply remains activated. The oxygen produced at the positive electrode remains localised in the main chamber 21, and causes the transfer of the electrolyte E into the secondary chamber 31 via the transfer duct 34. When the electrolyte E is no longer in physical contact with the solid-phase zinc layer 22, the electric power supply is deactivated and the valve V3 is closed.

FIG. 2C illustrates the electrochemical reactor 1 during the standby phase. In this withdrawal configuration, the control device ensures the physical separation of the electrolyte E and of the solid-phase zinc layer 22, so that the storage and supply device 20 does not produce gaseous hydrogen, and that the fuel cell 10 then produces no electrical energy.

The solid-phase zinc layer 22 is located in the attack main chamber 21, and the electrolyte E is located in the storage secondary chamber 31. The valves V1 and V2 are closed to avoid a return by gravity of the electrolyte E into the main chamber 21, as well as valve V3. The valve V4 is closed to fluidly isolate the fuel cell 10, and the valve V5 is also closed to avoid a possible evaporation of the electrolyte E. Thus, the electrochemical reactor 1 may remain in the standby phase for long periods of time, and presents reduced risks in terms of safety to the extent that the hydrogen is herein stored in the form of H⁺ ions in the electrolyte.

FIG. 2D illustrates the electrochemical reactor 1 during the gaseous hydrogen production phase. In this contact configuration, the control device 30 ensures the physical contact of the electrolyte E and of the solid-phase zinc layer 22, resulting in the oxidation of this layer 22 of the solid-phase metal M by the electrolyte E and therefore in the production of gaseous hydrogen, which is supplied to the fuel cell 10 which then produces electrical energy.

For this purpose, the valves V1 and V2 are open, and the valve V4 is also open. The electrolyte E is transferred (herein in part) into the main chamber 21, herein passively, by gravity, and naturally comes into contact with the solid-phase zinc layer 22.

This step is an electrochemical cell phenomenon. The oxidation of the solid zinc having been deposited over the negative electrode (anode) then takes place, as well as the reduction of the protons and therefore the production of gaseous hydrogen. This electrochemical reaction takes place spontaneously without any energy input, and in particular with no electrical or thermal energy, since zinc is not stable in an aqueous medium. The chemical equations are written as follows:

$$2 {H}^{+} + 2 {e}^{-} \to {H}_{2} ( g )$$

$$Zn ( s ) \to {Zn}^{2 +} + 2 {e}^{-}$$

Thus, gaseous hydrogen is formed in the attack main chamber 21, which is naturally transmitted up to the anode of the fuel cell 10 via the discharge duct 32, the storage secondary chamber 31 and the supply duct 23. The relief valve (cf. FIG. 1) herein allows regulating the pressure of the gaseous hydrogen at the inlet of the fuel cell 10 at a predefined value, for example equal to about 3 bar.

It should be noted that, by circulating in the discharge duct 32, the gaseous hydrogen causes the rise of the electrolyte E by gas lift effect like before with the production of gaseous oxygen. There is then a recirculation of the electrolyte E via the recirculation duct 33.

Thus, the electrochemical reactor 1 produces gaseous hydrogen and supplies it to the fuel cell 10. The latter also receives oxygen (air or pure oxygen) at the cathode, and thus produces electrical energy. The latter is transmitted, for example via an AC/DC converter (cf. FIG. 1) to the consumer equipment that needs it. It should be noted that the electric power supply remains deactivated, and that an electric current could be collected at the terminals of the electrodes and transmitted to the consumer equipment with the electrical energy produced by the fuel cell.

At the end of this gaseous hydrogen production phase, the electrochemical reactor 1 may be ‘prepared’ again by performing the preparation phase described before with reference to FIGS. 2A and 2B. All it needs then is to activate the electric power supply to produce a new solid-phase zinc layer 22 on the negative electrode 41, as well as H⁺ ions in the electrolyte E (FIG. 2A). The solid-phase zinc layer 22 thus obtained, the electrolyte E is then transferred out of the attack main chamber 21 to avoid any physical contact with the solid-phase zinc layer 22 (FIG. 2B). The electrochemical reactor 1 is then set in the withdrawal configuration for the standby phase.

Thus, the electrochemical reactor 1 according to the invention is able to store hydrogen in the chemical form of H⁺ ions (acidic electrolyte) or H₂O water molecules (basic electrolyte) and not in the gaseous phase and at high pressure as is the case in one of the examples of the aforementioned prior art. Thus, risks in terms of safety are reduced. In addition, the electrochemical reaction for producing gaseous hydrogen is initiated naturally, by simply bringing the solid-phase metal M layer 22 into contact with the electrolyte E, without there being any need for a thermal or electrical energy input. Finally, after production of gaseous hydrogen, the electrochemical reactor is able to produce a new solid-phase metal M layer and store hydrogen in its chemical form of H⁺ ions or H₂O water molecules. Thus, having to manually recharge the electrochemical reactor with solid metal M and with electrolyte is avoided. A simple water restocking may be provided for after the deposition step. Moreover, in this example, the transfer of the electrolyte E into the main chamber (for the gaseous hydrogen production phase) is performed by simple gravity. In addition, a recirculation of the electrolyte, during the gaseous hydrogen production, as well as during the gaseous oxygen production, allows homogenising its properties. The use cycle (production of gaseous hydrogen; formation of solid metal M; standby with the hydrogen stored in a non-gaseous form) is made possible, whether the electrodes are located in the main chamber 21 (FIGS. 1 and 3) or they are located in the intermediate chamber 45 (FIG. 4).

FIG. 3 is a schematic and partial view of an electrochemical reactor 1 according to a variant of the first embodiment, wherein the storage secondary chamber 31 is not located above the attack main chamber 21, but is located next to the latter (laterally).

Like before, the secondary chamber 31 allows accommodating the electrolyte E during the standby phase, and fluidic elements ensure the transfer of the electrolyte E between the attack main chamber 21 and the storage secondary chamber 31.

Thus, the storage secondary chamber 31 is herein connected to the attack main chamber 21 by a transfer duct 34 connecting a lower port of the main chamber 21 to a lower port of the secondary chamber 31. In general, a lower, resp. upper, port is an opening located in a lower, resp. upper, portion of the considered chamber. The transfer duct 34 herein includes a two-way pump 51 ensuring pumping of the electrolyte E from the main chamber 21 to the secondary chamber 31, and vice versa. A valve V3 and a filter 52 are also present.

The secondary chamber 31 and the main chamber 21 are both connected to the degasser 26, each by a discharge duct 25, 25.1 provided with a valve, respectively V5, V6. Moreover, a bottle of a neutral gas 35 under pressure is herein connected to the main chamber 21 as well as to the secondary chamber 31, to assist the fluidic transfer from one chamber to the other.

Moreover, the supply duct 23 is herein equipped with a deflector 53 (also called demister) which allows removing any acid mist possibly present, with a valve V4 and with a filter 54. Of course, these fluidic elements may equip the supply duct of the electric generator of the first embodiment (FIG. 1).

In operation, the electrochemical reactor 1 includes a preparation phase, in which the control device 30 places at least one portion of the electrolyte E in the main chamber 21, in contact with the electrodes 41, 42, and activates the electric power supply 43 to produce the solid-phase metal M layer 22 on the negative electrode 41. This deposition step is accompanied by a production of gaseous oxygen at the positive electrode 42 which may be discharged out of this chamber 21 towards the degasser 26. The supply valve V4 remains closed.

At the end of this step, either by means of the produced oxygen (as described before with reference to FIG. 2B), and/or by means of the pump and/or by means of the injection of a neutral gas under pressure, the electrolyte E present in the main chamber 21 is discharged so that there is a physical separation with the layer 22 of the solid-phase metal M. The transfer valve V3 is closed, as well as the discharge valves V5 and V6. The electric generator is then in a withdrawal configuration for the standby phase.

When the production of gaseous hydrogen is required, the control device 30 performs the transfer of at least one portion of the electrolyte E into the main chamber 21 to come into contact with the layer 22 of the solid-phase metal M. The electric power supply 43 herein remains deactivated. On the other hand, the supply valve V4 is open. This physical contact between the electrolyte E and the layer 22 of the solid-phase metal M results in the production of gaseous hydrogen, which is naturally transmitted to the anode of the fuel cell 10 by means of the supply duct 23.

As mentioned before with reference to FIG. 2A to 2D, when the gaseous hydrogen production phase, the electrochemical reactor 1 may proceed with a new preparation phase. Thus, a new solid-phase metal M layer 22 is obtained, and the electrolyte E is recharged again with H⁺ ions (acidic electrolyte) or with H₂O water molecules (basic electrolyte).

It should be noted that the electrochemical reactor 1 may include a recirculation circuit, adapted to ensure the recirculation of the electrolyte between the two chambers 21 and 31 during the deposition step and/or during the attack step. It may then include a duct connecting a lower portion of the main chamber with an upper portion of the secondary chamber, and a duct connecting an upper portion of the main chamber with a lower portion of the secondary chamber. A pump may ensure the recirculation of the electrolyte.

FIG. 4 is a schematic and partial view of an electrochemical reactor 1 according to a second embodiment, wherein the control device 30 enablers the movement of the solid-phase metal M layer 22 to separate the latter from the electrolyte E during the standby phase.

In addition, in this example, the storage and supply device 20 includes three chambers, namely an attack main chamber 21 where the oxidation of the solid-phase metal M layer 22 takes place by the electrolyte E and therefore the production of gaseous hydrogen, a storage secondary chamber 31 to accommodate the electrolyte E in the standby phase, and a deposition intermediate chamber 45 where the step of depositing the solid-phase metal M layer 22 herein takes place on the negative electrode 41.

More specifically, the deposition intermediate chamber 45 is that where the negative 41 and positive 42 electrodes are located. It is connected to the storage secondary chamber 31 by a discharge duct 46 at an upper port 45.1, by a recirculation duct 47 and by a transfer duct 48. These different ducts are provided with valves V1i, V2i, V3i.

The attack main chamber 21 is connected to the storage secondary chamber 31 by a discharge duct 32 at an upper port 21.1, by a recirculation duct 33 and by a transfer duct 34. These different ducts 32, 33, 34 are also provided with valves V1, V2, V3.

The storage secondary chamber 31 is herein connected to the degasser 26 by a discharge duct 25, and to the fuel cell 10 by a supply duct 23.

FIGS. 5A to 5D schematically and partially illustrate the electrochemical reactor 1 according to a second embodiment similar to that described in FIG. 4, during different stages of operation thereof. Like before, in this example, the electrolyte E is acidic and the redox intermediate is the Zn²⁺/Zn couple.

FIGS. 5A and 5B illustrate a preparation step. During a first step, the layer 22 of the solid-phase zinc metal is formed in the deposition intermediate chamber 45. For this purpose, the electric power supply is activated and the electrolyte E is brought into contact with the electrodes. The valves V1i and V2i are open, while valves V3i, V1, V2 and V3 remain closed. In addition, the supply valve V4 remains closed and the discharge valve V5 is open. Also, the electrolyte E herein circulates between the deposition intermediate chamber 45 and the storage secondary chamber 31 by gas lift effect via the recirculation duct. The solid-phase zinc layer 22 forms on the negative electrode. The oxygen produced is discharged throughout the storage secondary chamber 31 and the degasser.

During the second step, as described with reference to FIG. 2B, the electrolyte E is transferred into the storage secondary chamber 31 to physically separate it from the solid-phase zinc layer 22. The valves V1i and V2i are closed and valve V3i is open. The oxygen produced in the deposition intermediate chamber 45 allows discharging the electrolyte E.

Afterwards, the valve V3i is closed. FIG. 5C illustrates the standby phase. The control device 30 enables the transfer of the solid-phase zinc layer 22 from the deposition intermediate chamber 45 to place it in the attack main chamber 21. This transfer may be done manually or mechanically. The electrochemical reactor 1 may remain in this configuration for the necessary time.

It should be noted that the amount of solid-phase zinc located in the attack main chamber 21 may be increased so as to optimise the amount of hydrogen gas subsequently produced. For this purpose, the steps of forming the solid-phase zinc layer 22 (FIG. 5A), discharge of the electrolyte E (FIG. 5B) then transfer into the main chamber 21 of the zinc layer 22 thus formed (FIG. 5C) are performed several times. Thus, the amount of solid-phase zinc arranged in the attack main chamber 21 may be significant, as is the amount of H⁺ ions present in the electrolyte E.

FIG. 5D illustrates the gaseous hydrogen production phase. The valves V1 and V2 are open, as well as the supply valve V4. The electrolyte E naturally falls into the attack main chamber 21 and oxidises the solid-phase zinc layer 22, thus resulting in the production of gaseous hydrogen. This gaseous hydrogen is discharged through the discharge duct with the valve V1, the storage secondary chamber 31, the supply duct with the valve V4, and is brought to supply the fuel cell 10, which then produces electrical energy. This movement of the gaseous hydrogen causes a recirculation of the electrolyte E between the attack main chamber 21 and the storage secondary chamber 31, via the discharge and recirculation ducts, thereby improving the homogeneity of the concentration of the H⁺ ions and therefore the oxidation of the solid-phase zinc layer.

The advantages of the electrochemical reactor are herein the same as those of the first embodiment. Nonetheless, as indicated before, it is possible to increase the amount of produced solid-phase zinc, and therefore increase the produced gaseous hydrogen.

Particular embodiments have just been described. Different variants and modifications will appear to a person skilled in the art.

Moreover, depending on the applications, the hydrogen engine could be not permanently connected to the hydrogen storage and supply device. The connection may be performed during the gaseous hydrogen production phase. Other equipment may be connected to the electrochemical reactor 1, other than only hydrogen engines.

What is claimed is:

1. An electrochemical reactor, intended to produce gaseous hydrogen on demand, including:
a hydrogen storage and supply device, configured to store hydrogen and to produce and supply gaseous hydrogen, including:
a layer of a solid-phase metal M of a redox couple Mⁿ⁺/M, and an aqueous liquid electrolyte configured to oxidise the layer of the solid-phase metal M resulting in the production of gaseous hydrogen;
a main chamber, configured to receive the electrolyte and the layer of the solid-phase metal M, and including an outlet for supplying the gaseous hydrogen;
a control device, configured to ensure a relative movement between the electrolyte and the metal M layer, so as to be able to successively present at least the following two configurations:
a withdrawal configuration during a standby phase, where there is a physical separation between the electrolyte and the metal M layer; and
a contact configuration during a production phase, where there is physical contact between the electrolyte and the metal M layer in the main chamber, resulting in the oxidation of this layer of the metal M by the electrolyte and therefore in the production of gaseous hydrogen;
wherein the storage and supply device includes:
a secondary chamber, fluidly connected to the main chamber, and configured to receive the electrolyte at least during the standby phase;
a negative electrode and a positive electrode, and an electric power supply connected to the electrodes, the control device being configured to have: a contact configuration during a preparation phase, following a production phase, in which there is physical contact between the electrolyte and the electrodes, the electric power supply being activated, resulting in a deposition of the solid-phase metal M layer over the negative electrode and in a production of gaseous oxygen at the positive electrode, the metal M layer thus formed being intended to be oxidised by the electrolyte during a subsequent production phase,
the negative and positive electrodes being located: either in the main chamber; or in an intermediate chamber fluidly connected to the secondary chamber, the control device then being configured to move the metal M layer from the intermediate chamber following the preparation phase, in the main chamber for the production phase.

2. The electrochemical reactor according to claim 1, wherein the main chamber and the secondary chamber are connected to each other by an electrolyte recirculation circuit.

3. The electrochemical reactor according to claim 2, wherein the electrolyte has a volume larger than that of the main chamber and smaller than or equal to that of the secondary chamber.

4. The electrochemical reactor according to claim 2, wherein the negative and positive electrodes are located in the intermediate chamber, the electrolyte having a volume larger than that of the intermediate chamber and smaller than or equal to that of the secondary chamber.

5. The electrochemical reactor according to claim 2, wherein the secondary chamber is located above the main chamber, the recirculation circuit including discharge and recirculation ducts, the discharge duct opening onto an upper port of the main chamber and the recirculation duct opening onto a lower port of the secondary chamber.

6. The electrochemical reactor according to claim 5, wherein the hydrogen storage and supply device is configured to move, during the production phase, at least one portion of the electrolyte by gravity in the main chamber, to come into contact with the solid-phase metal M layer.

7. The electrochemical reactor according to claim 1, wherein the negative and positive electrodes are located in the intermediate chamber, the secondary chamber being located above the intermediate chamber and the main chamber, and being connected:
to the intermediate chamber via a discharge duct and a recirculation duct, the discharge duct opening onto an upper port of the intermediate chamber and the recirculation duct opening onto a lower port of the secondary chamber so as to enable a recirculation of the electrolyte between the secondary and intermediate chambers during the preparation phase;
to the main chamber by a discharge duct and a recirculation duct, the discharge duct opening onto an upper port of the main chamber and the recirculation duct opening onto one lower port of the secondary chamber so as to enable a recirculation of the electrolyte between the secondary and main chambers during the production phase.

8. The electrochemical reactor according to claim 6, wherein the storage and supply device includes a transfer duct connecting the intermediate chamber and the secondary chamber, and opening onto a lower port of the intermediate chamber.

9. An hydrogen electric generator, intended to produce electrical energy from gaseous hydrogen, including:
an electrochemical reactor according to claim 1;
a hydrogen engine, configured to produce electrical energy from the gaseous hydrogen supplied by the storage and supply device of the electrochemical reactor, including an inlet manifold for receiving the hydrogen, connected to the main chamber.

10. The hydrogen electric generator according to claim 9, where the inlet manifold is connected to the main chamber via the secondary chamber.

11. A method for producing gaseous hydrogen by the electrochemical reactor according to claim 1, including the following steps:
during the standby phase, physically separating the electrolyte and the solid-phase metal M layer, by the control device, so as to present the withdrawal configuration; then
during the production phase, bringing the electrolyte and the solid-phase metal M layer into contact in the main chamber, by the control device, resulting in the oxidation of this layer of the solid-phase metal M by the electrolyte and therefore in the production of gaseous hydrogen; then
during the preparation phase, bringing the electrolyte into contact with the negative and positive electrodes, the electric power supply being activated, resulting in a deposition of the solid-phase metal M layer over the negative electrode and in a production of gaseous oxygen at the positive electrode.

12. The gaseous hydrogen production method according to claim 11, including, after the preparation phase, a new cycle formed by the standby, production and preparation phases.

13. A method for producing electrical energy by the hydrogen electric generator according to claim 9, including:
during the standby phase, physical separation of the electrolyte and the solid metal M layer, by the control device, so as to present the withdrawal configuration; then
during the production phase, bringing the electrolyte and the solid-phase metal M layer into contact in the main chamber, by the control device, resulting in the oxidation of this layer of the solid-phase metal M by the electrolyte and therefore in the production of gaseous hydrogen, which is supplied to the hydrogen engine, which then produces electrical energy; then
during the preparation phase, bringing the electrolyte into contact with the negative and positive electrodes, the electric power supply being activated, resulting in a deposition of the solid-phase metal M layer over the negative electrode and in a production of gaseous oxygen at the positive electrode.
